(19) United States
(12) Patent Application Publication
(10) Pub. No.: US 2026/0075504 A1
(43) Pub. Date: Mar. 12, 2026

(54) COMMUNICATION OF SYSTEM INFORMATION

(71) Applicant: Samsung Electronics Co., Ltd., Suwon-si (KR)

(72) Inventor: Hongbo Si, Allen, TX (US)

(21) Appl. No.: 19/300,467

(22) Filed: Aug. 14, 2025

Related U.S. Application Data
(60) Provisional application No. 63/691,723, filed on Sep. 6, 2024.

(51) Int. Cl. H04W 48/14; H04L 5/00; H04W 72/23

(52) U.S. Cl. CPC H04W 48/14; H04L 5/0048; H04W 72/23

(57) ABSTRACT

Methods and apparatuses for communication of system information. A method of a user equipment (UE) in a wireless communication system includes receiving a synchronization signals and physical broadcast channel (SS/PBCH) block including a primary synchronization signal (PSS) and a secondary synchronization signal (SSS), determining, based on the SS/PBCH block, configurations for a first control resource set (CORESET) to monitor a first physical downlink control channel (PDCCH), and receiving the first PDCCH based on the first CORESET. The method further includes determining, based on the first PDCCH, configurations related to a request for a system information block, and configurations for a second CORESET to monitor a second PDCCH, transmitting the request for the system information block, receiving the second PDCCH based on the second CORESET, and receiving a physical downlink shared channel (PDSCH) scheduled by the second PDCCH, wherein the PDSCH includes the system information block.

### CROSS-REFERENCE TO RELATED AND CLAIM OF PRIORITY

The present application claims priority under 35 U.S.C. § 119(e) to U.S. Provisional Patent Application No. 63/691,723 filed on Sep. 6, 2024, which is hereby incorporated by reference in its entirety.

### TECHNICAL FIELD

The present disclosure relates generally to wireless communication systems and, more specifically, the present disclosure relates to methods and apparatuses for communication of system information.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to communication of system information.

In one embodiment, a base station (BS) in a wireless communication system is provided. The BS includes a processor configured to determine configurations for a first control resource set (CORESET) to monitor a first physical downlink control channel (PDCCH), determine configurations related to a request for a system information block, and determine configurations for a second CORESET to monitor a second PDCCH. The BS further includes a transceiver operably coupled to the processor. The transceiver is configured to transmit a synchronization signals and physical broadcast channel (SS/PBCH) block including a primary synchronization signal (PSS) and a secondary synchronization signal (SSS) and the configurations for the first CORESET, transmit the first PDCCH based on the first CORESET that includes (i) the configurations related to the request for the system information block and (ii) the configurations for the second CORESET, receive the request for the system information block, transmit the second PDCCH based on the second CORESET, and transmit a physical downlink shared channel (PDSCH) scheduled by the second PDCCH and that includes the system information block.

In another embodiment, a user equipment (UE) in a wireless communication system is provided. The UE includes a transceiver configured to receive a SS/PBCH block including a PSS and a SSS and a processor operably coupled to the transceiver. The processor configured to determine, based on the SS/PBCH block, configurations for a first CORESET to monitor a first PDCCH. The transceiver is further configured to receive the first PDCCH based on the first CORESET. The processor is further configured to determine, based on the first PDCCH, configurations related to a request for a system information block and configurations for a second CORESET to monitor a second PDCCH. The transceiver is further configured to transmit the request for the system information block, receive the second PDCCH based on the second CORESET, and receive a PDSCH scheduled by the second PDCCH and that includes the system information block.

In yet another embodiment, a method of a UE in a wireless communication system is provided. The method includes receiving a SS/PBCH block including a PSS and a SSS, determining, based on the SS/PBCH block, configurations for a first CORESET to monitor a first PDCCH, and receiving the first PDCCH based on the first CORESET. The method further includes determining, based on the first PDCCH, configurations related to a request for a system information block, and configurations for a second CORESET to monitor a second PDCCH, transmitting the request for the system information block, receiving the second PDCCH based on the second CORESET, and receiving a PDSCH scheduled by the second PDCCH, wherein the PDSCH includes the system information block.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates a signal flow of an example procedure for receiving SIB0 and SIB1 according to embodiments of the present disclosure;

FIG. 6 illustrates example transmission patterns according to embodiments of the present disclosure; and

FIG. 7 illustrates an example method performed by a UE in a wireless communication system according to embodiments of the present disclosure.

### DETAILED DESCRIPTION

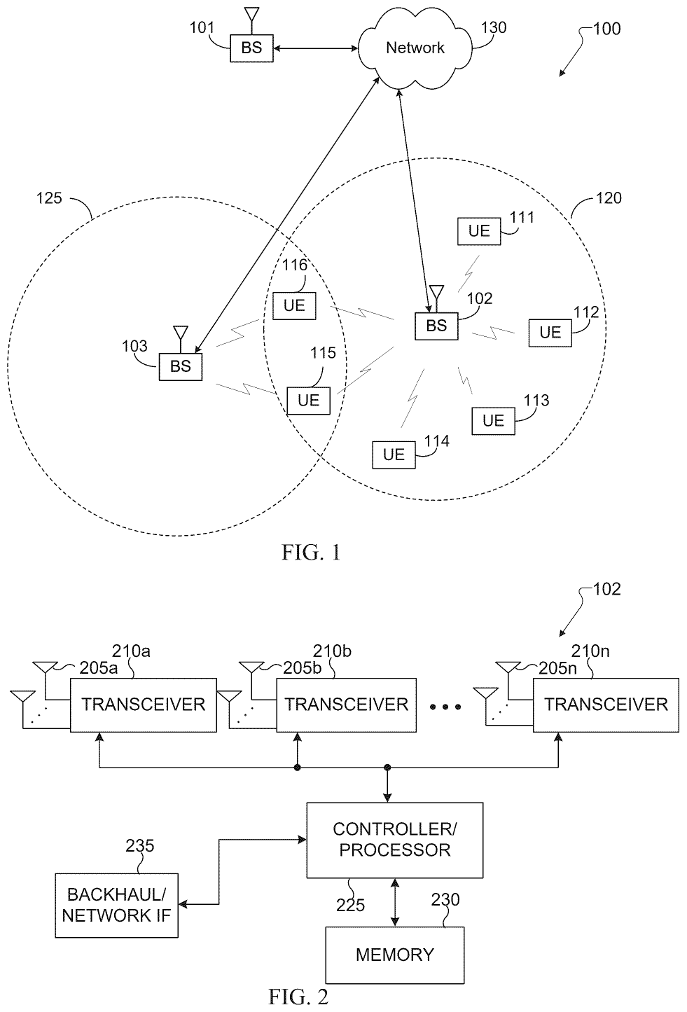

FIGS. 1-7, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP TS 38.211 v18.0.0, “NR; Physical channels and modulation;” [REF 2]3GPP TS 38.212 v18.0.0, “NR; Multiplexing and channel coding;” [REF 3]3GPP TS 38.213 v18.0.0, “NR; Physical layer procedures for control;” [REF 4]3GPP TS 38.214 v18.0.0, “NR; Physical layer procedures for data;” and [REF 5]3GPP TS 38.331 v18.0.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for communication of system information. In certain embodiments, one or more of the BSs 101-103 include circuitry, programing, or a combination thereof to support communication of system information.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by ULEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as communication of system information. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

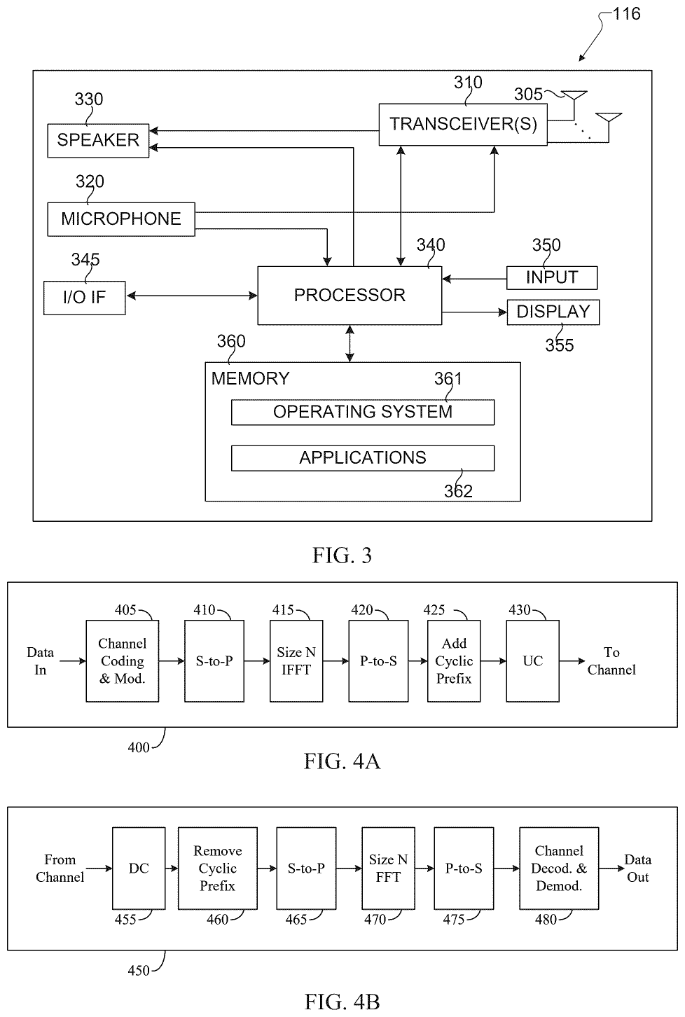

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to identify and control communication of system information as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support communication of system information as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In NR Rel-15, system information can be delivered to a UE by one of a master information block (MIB) carried by a physical broadcast channel (PBCH), or a system information block 1 (SIB1) carried by a periodically transmitted physical downlink shared channel (PDSCH) scheduled by a Type0-PDCCH, or a system information block x (SIBx) carried by on-demand PDSCH, where x>1. The configuration for receiving Type0-PDCCH is carried by MIB, and the scheduling information for the PDSCH carrying SIB1 is carried by a downlink control information (DCI) format in the Type0-PDCCH.

Embodiments of the present disclosure recognizes that, for a new generation of wireless communication, there is a need to reduce the periodic transmission of signal(s) or channel(s), in order to save energy for at least a base station or a UE. For example, system information (e.g., SIB1) transmission can be non-periodic, and the transmission is performed only when it is required, e.g., subject to a UE's request. This disclosure focuses on mechanism to support on-demand system information transmission, e.g., for the case of single cell operation wherein the UE request and the system information transmission are performed on the same cell.

This disclosure focuses on delivering system information with two system information blocks. More precisely, the following aspects are covered by the disclosure.
General instances on two system information blocks
Design for SIB0
   PBCH based design
   2nd-PBCH based design
   physical downlink control channel (PDCCH) based design
   PDCCH+PDSCH based design

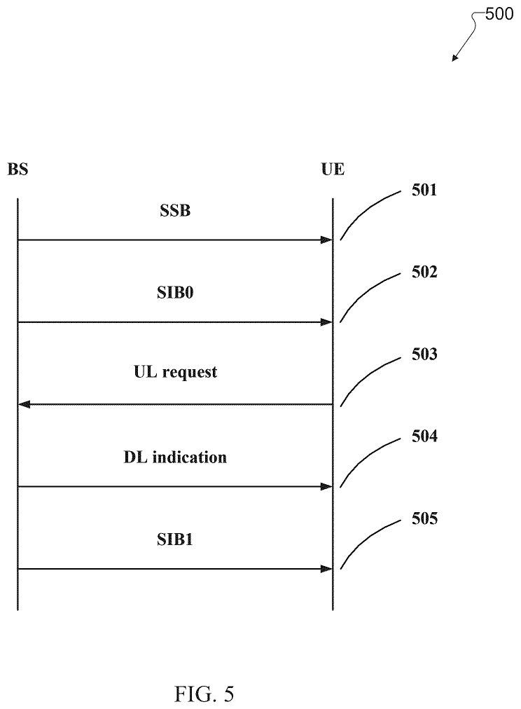

FIG. 5 illustrates a signal flow of an example procedure 500 for receiving SIB0 and SIB1 according to embodiments of the present disclosure. For example, procedure 500 can be performed by the UE 116 and the gNB 102 and/or network 130 in the wireless network 100 of FIG. 1. This example is for illustration only and other embodiments can be used without departing from the scope of the present disclosure.

The procedure begins in 501, a BS transmits a SSB to a UE. In 502, the BS transmits a SIB0 to the UE. In 503, the UE transmits a UL request to the BS. In 504, the BS transmits a DL indication to the UE. In 505, the BS transmits a SIB1 to the UE.

In one embodiment, a UE can receive at least two types of system information blocks, including a first system information block and a second system information block. For instance, the first system information block can be denoted as SIB0, and the second system information block can be denoted as SIB1.

For one example, an illustration of the procedure for receiving SIB0 and SIB1 is shown in FIG. 5.
For one instance, the step 503 in FIG. 5 (e.g., UL request) can be absent in some example procedures, and the transmission of SIB1 can be indicated by the BS without UE's request.
For another instance, the step 504 in FIG. 5 (e.g., DL indication) can be absent in some example procedures, and the transmission of SIB1 can be requested by the UE without BS's indication.

For another example, the payload size of SIB0 can be smaller than or no larger than the payload size of SIB1.
For one instance, at least part of the payload of SIB0 can be also included in the payload of SIB1.
For another instance, the payload of SIB0 can be also included in the payload of SIB1.
For another instance, when a same field is included in both SIB0 and SIB1, the field in SIB1 overrides the field in SIB0.

For yet another example, the time and/or frequency resources (e.g., in term of a number of REs) for SIB0 can be smaller than or no larger than the time and/or frequency resources (e.g., in term of a number of REs) of SIB1.
For one instance, the time domain resources (e.g., the OFDM symbol indexes) for SIB0 can be a subset of the time domain resources (e.g., the OFDM symbol indexes) for SIB1.
For another instance, the frequency domain resources (e.g., the resource blocks) for SIB0 can be a subset of the frequency domain resources (e.g., the resource blocks) for SIB1.

For yet another example, the transmission of SIB0 can be in a multi-beam manner (e.g., a burst of transmissions for SIB0).
For one instance, a transmission for SIB0 can be quasi co-located (QCLed) with a transmission of SSB, e.g., the RS (e.g., demodulation reference signal (DM-RS)) associated with SIB0 can be QCLed with signals in SSB. For one further consideration, the instance can be applicable when an index of the SIB0 (e.g., index with a burst of SIB0) is same as an index of the SSB (e.g., index within a burst of SSB).

For yet another example, the transmission of SIB1 can be associated with a transmission of the UL request and/or the DL indication.
For one instance, the RS (e.g., DM-RS) associated with SIB1 can be QCLed with the signal associated with the UL request and/or the DL indication.
For another instance, the RS (e.g., DM-RS) associated with SIB1 can be QCLed with the QCL source of the UL request and/or the DL indication (e.g., a SSB).
For yet another instance, the example can be applicable when a higher layer parameter is provided.

For yet another example, the payload of SIB0 can include configurations for the proceeding procedure(s).
For one instance, the payload of SIB0 can include configurations for the UL request, e.g., the time and/or frequency and/or power domain resource information, and/or parameters for the sequence generated for the UL request.
For another instance, the payload of SIB0 can include configurations for the DL indication, e.g., the time and/or frequency and/or power domain resource information, and/or CORESET configuration, and/or search space set configuration, and/or subcarrier spacing, and/or k_SSB value (e.g., k_SSB value can be used for determining a subcarrier-level offset between the SSB and common resource grid).
For yet another instance, the payload of SIB0 can include configurations for the SIB1, e.g., CORESET configuration, and/or search space set configuration, and/or subcarrier spacing, and/or k_SSB value.

For yet another example, the UL request can be carried by a physical uplink channel.
For one instance, the UL request can be a PRACH (e.g., Msg1 in a 4-step random access procedure).
For another instance, the UL request can be a MsgA in a 2-step random access procedure.
For yet another instance, the UL request can be a Msg3 in a 4-step random access procedure.
For yet another instance, the UL request can be a scheduling request (SR) and/or included in UCI (e.g., carried by a physical uplink control channel (PUCCH) and/or a physical uplink shared channel (PUSCH)).

For yet another example, the DL indication can be carried by a physical downlink channel.
For one instance, the DL indication can be a RAR (e.g., Msg2 in a 4-step random access procedure).
For another instance, the DL indication can be a MsgB in a 2-step random access procedure.
For yet another instance, the DL indication can be a Msg4 in a 4-step random access procedure.
For yet another instance, the DL indication can be a PDCCH scheduling a PDSCH (e.g., including UE's data).
For yet another instance, the DL indication can be a group common PDCCH.

For yet another example, the SIB1 can be carried by a PDSCH, and the PDSCH is scheduled by a PDCCH. For this example, the PDSCH carrying the SIB1 is denoted as SIB1-PDSCH, and the associated PDCCH is denoted as SIB1-PDCCH.
For one instance, the SIB1-PDCCH is monitored in a common search space (CSS) set.
For another instance, the resources for SIB1-PDCCH can be included in a control resource set (CORESET), which can be denoted as SIB1-CORESET.

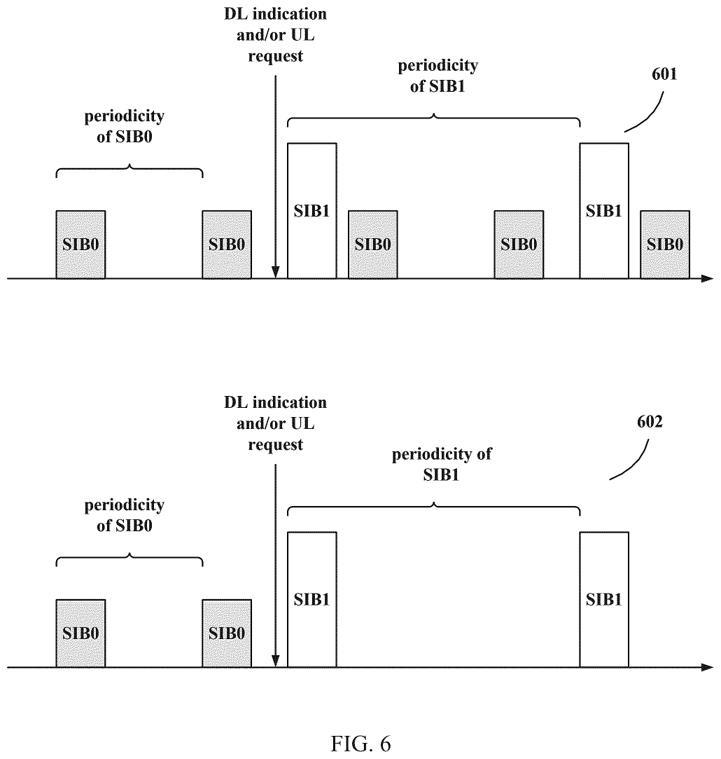

FIG. 6 illustrates example transmission patterns 601 and 602 according to embodiments of the present disclosure. For example, transmission patterns 601 and 602 can be followed by the UE 116 and the gNB 102 and/or network 130 in the wireless network 100 of FIG. 1. This example is for illustration only and other embodiments can be used without departing from the scope of the present disclosure.

For yet another example, the transmission of SIB0 and/or SIB1 can be according to at least one of two transmission patterns.
For a first transmission pattern (e.g., denoted as SIB0/SIB1 transmission pattern 1), the transmission of SIB0 can be periodic (e.g., transmission is on with a periodicity and without UE's request or BS's indication), and the transmission of SIB1 can be on-demand (e.g., transmission is not always-on and triggered based on UE's request and/or BS's indication). An illustration of the SIB0/SIB1 transmission pattern 1 is shown in 601 of FIG. 6.
   For one further instance of SIB0/SIB1 transmission pattern 1, the time and/or frequency domain resources for PDSCH of on-demand SIB1 do not overlap with the time and/or frequency domain resources for PDSCH of on-demand SIB0.
For a second transmission pattern (e.g., denoted as SIB0/SIB1 transmission pattern 2), the transmission of SIB0 and the transmission of SIB1 can be interleaved. The transmission of SIB1 can be on-demand (e.g., transmission is not always-on and triggered based on UE's request and/or BS's indication), and when SIB1 is not transmitted, SIB0 is transmitted. An illustration of the SIB0/SIB1 transmission pattern 1 is shown in 602 of FIG. 6.

In one embodiment, SIB0 can be carried by at least one physical downlink channel.

For one example, SIB0 can be carried by a physical broadcast channel (PBCH), wherein the PBCH carrying SIB0 can be same as the PBCH carrying MIB. For this example, SIB0 can be regarded as part of the payload carried by PBCH in addition to MIB, or SIB0 can be regarded as a part of MIB (and a part of SSB). For one further consideration, there can be an indication in the MIB on whether the SIB0 is present, e.g., in the same payload of PBCH.

For one example, SIB0 can be carried by a PBCH, wherein the PBCH carrying SIB0 can be different from the PBCH carrying MIB. For one further instance, the PBCH carrying SIB0 is denoted as 2nd-PBCH. For another further instance, the PBCH carrying SIB0 can also be treated as a PDSCH without an associated PDCCH carrying its scheduling information.

For one instance, the 2nd-PBCH can have a one-to-one association with a PBCH in a SSB, e.g., DM-RS of the 2nd-PBCH is QCLed with the associated DM-RS of the PBCH in the SSB. For one further consideration, the instance can be applicable when an index of the 2nd-PBCH (e.g., index within a burst of 2nd-PBCH) is same as an index of the PBCH (e.g., index within a burst of PBCH).

For another instance, the 2nd-PBCH has a fixed or pre-determined time domain and/or frequency domain and/or power domain resource.
For one sub-instance, the OFDM symbols for the 2nd-PBCH can be same as the OFDM symbols for the associated PBCH, and/or the bandwidth (e.g., a number of resource blocks (RBs) or a number of subcarriers) can be fixed. The 2nd-PBCH can be frequency division multiplexed (FDMed) or interleaved frequency division multiplexed (IFDMed) with the associated PBCH.
For another sub-instance, the bandwidth (e.g., a number of RBs or a number of subcarriers) of the 2nd-PBCH can be same as the bandwidth of the associated PBCH, and the OFDM symbols for the 2nd-PBCH can be different from the associated PBCH. The 2nd-PBCH can be time division multiplexed (TDMed) with the associated PBCH.
For yet another sub-instance, the subcarrier spacing of the 2nd-PBCH can be same as the subcarrier spacing of the (associated) PBCH.
For yet another sub-instance, the power (e.g., energy per resource element (EPRE)) of the 2nd-PBCH can be same as the power (e.g., EPRE) of the (associated) PBCH.

Fort yet another instance, the channel coding scheme for the 2nd-PBCH can be the same as the (associated) PBCH, e.g., polar coding.

Fort yet another instance, the modulation scheme for the 2nd-PBCH can be the same as the (associated) PBCH, e.g., quadrature phase shift keying (QPSK).

For one example, SIB0 can be carried by a physical downlink control channel (PDCCH), which can be denoted as SIB0-PDCCH.

For one instance, SIB0-PDCCH can be same as SIB1-PDCCH, e.g., a single DCI format carrying the payload of SIB0 and/or other information (e.g., scheduling information) for the SIB1-PDSCH.
For one sub-instance, the configurations for CORESET and/or search space set for monitoring SIB0-PDCCH/SIB1-PDCCH can be included in the payload of PBCH (e.g., MIB).
For another sub-instance, the DCI format in the SIB0-PDCCH/SIB1-PDCCH can carry the payload of SIB0 by default, and also include the information related to the SIB1-PDSCH when the on-demand SIB1 is transmitted.
   For one further instance, there can be a field (e.g., one-bit indication) in the DCI format indicating whether the DCI format includes the information related to the SIB1-PDSCH (e.g., whether on-demand SIB1 is transmitted).
   For another further instance, there can be a field (e.g., one-bit indication or indication by k_SSB value) in the PBCH payload indicating whether the DCI format includes the information related to the SIB1-PDSCH (e.g., whether on-demand SIB1 is transmitted).
   For yet another further instance, this can be applicable at least for SIB0/SIB1 transmission pattern 1.
For yet another sub-instance, the DCI format in the SIB0-PDCCH/SIB1-PDCCH can carry the payload of SIB0 when the on-demand SIB1 is not transmitted, and include the information related to the SIB1-PDSCH when the on-demand SIB1 is transmitted.
   For one further instance, there can be a field (e.g., one-bit indication) in the DCI format indicating whether the DCI format includes the payload of SIB0 or the information related to the SIB1-PDSCH (e.g., whether on-demand SIB1 is transmitted).
   For another further instance, there can be a field (e.g., one-bit indication or indication by k_SSB value) in the PBCH payload indicating whether the DCI format includes the payload of SIB0 or the information related to the SIB1-PDSCH (e.g., whether on-demand SIB1 is transmitted).
   For yet another further instance, this can be applicable at least for SIB0/SIB1 transmission pattern 2.

For another instance, SIB0-PDCCH can be different from SIB1-PDCCH.
For one sub-instance, the configurations for CORESET for SIB0-PDCCH/SIB1-PDCCH can be the same, and included in the payload of PBCH (e.g., MIB).
For another sub-instance, the configurations for CORESET for the SIB0-PDCCH and the configurations for CORESET for the SIB1-PDCCH can be the different.
   For one further instance, the configurations for CORESET for the SIB0-PDCCH can be included in the payload of PBCH (e.g., MIB), and/or the configurations for CORESET for the SIB1-PDCCH can be included in the SIB0.
   For another further instance, the configurations for CORESET for the SIB0-PDCCH can be included in the payload of PBCH (e.g., MIB), and/or the configurations for CORESET for the SIB1-PDCCH can be determined based on the configurations for CORESET for the SIB0-PDCCH, such as the same number of OFDM symbols and frequency division multiplexed (FDMed) with CORESET for the SIB0-PDCCH, or the same number of RBs and time division multiplexed (TDMed) with CORESET for the SIB0-PDCCH.
   For one further instance, the configurations for CORESET for the SIB0-PDCCH can be included in the payload of PBCH (e.g., MIB), and/or the configurations for CORESET for the SIB1-PDCCH can be also included in the payload of PBCH (e.g., MIB), such as two different fields, or at least one field for common configurations for the two CORESETs and another at least one field for unique configurations for each CORESET respectively, or one field for configurations for one of the CORESETs and another at least one field for indicating difference (e.g., time and/or frequency domain offset) from the configurations for one of the CORESETs to determine the configurations for the other of the CORESETs.
   For one further instance, the configurations for CORESET for the SIB0-PDCCH can be determined (e.g., time and/or frequency domain can be determined based on the associated SSB), and/or the configurations for CORESET for the SIB1-PDCCH can be included in the payload of PBCH (e.g., MIB).
   For one further instance, the configurations for CORESET for the SIB0-PDCCH can be determined (e.g., time and/or frequency domain can be determined based on the associated SSB), and/or the configurations for CORESET for the SIB1-PDCCH can be included in the SIB0.
For another sub-instance, the configurations for the search space set for monitoring SIB0-PDCCH/SIB1-PDCCH can be the same, and included in the payload of PBCH (e.g., MIB).
For yet another sub-instance, the configurations for search space set for monitoring the SIB0-PDCCH and the configurations for search space set for monitoring the SIB1-PDCCH can be the different.
   For one further instance, the configurations for search space set for monitoring the SIB0-PDCCH can be included in the payload of PBCH (e.g., MIB), and the configurations for search space set for monitoring the SIB1-PDCCH can be included in the SIB0.
   For another further instance, the configurations for search space set for monitoring the SIB0-PDCCH can be included in the payload of PBCH (e.g., MIB), and the configurations for search space set for monitoring the SIB1-PDCCH can be determined based on the configurations for search space set for monitoring the SIB0-PDCCH, such as with a pre-defined or configured time domain offset.
   For one further instance, the configurations for search space set for monitoring the SIB0-PDCCH can be included in the payload of PBCH (e.g., MIB), and the configurations for search space set for monitoring the SIB1-PDCCH can be also included in the payload of PBCH (e.g., MIB), such as two different fields, or at least one field for common configurations for the two search space sets and another at least one field for unique configurations for each search space set respectively, or one field for configurations for one of the search space sets and another at least one field for indicating difference (e.g., time and/or frequency domain offset) from the configurations for one of the search space sets to determine the configurations for the other of the search space sets.
   For one further instance, the configurations for the search space set for monitoring the SIB0-PDCCH can be determined (e.g., time and/or frequency domain can be determined based on the associated SSB), and/or the configurations for the search space set for monitoring the SIB1-PDCCH can be included in the payload of PBCH (e.g., MIB).
   For one further instance, the configurations for the search space set for monitoring the SIB0-PDCCH can be determined (e.g., time and/or frequency domain can be determined based on the associated SSB), and/or the configurations for the search space set for monitoring the SIB1-PDCCH can be included in the SIB0.
For yet another sub-instance, a first DCI format in the SIB0-PDCCH can carry the payload of SIB0, and a second DCI format in the SIB1-PDCCH can carry the information related to the SIB1-PDSCH.
For yet another sub-instance, the UE (e.g., the UE 116) monitors SIB0-PDCCH, and also monitors SIB1-PDCCH when the on-demand SIB1 is transmitted.
   For one further instance, there can be a field (e.g., one-bit indication) in the first DCI format indicating whether to monitor the SIB1-PDCCH (e.g., whether on-demand SIB1 is transmitted, or whether the CORESET for SIB1 is present when the CORESET for SIB0 is different from the CORESET for SIB1).
   For another further instance, there can be a field (e.g., one-bit indication or indication by k_SSB value) in the PBCH payload indicating whether to monitor the SIB1-PDCCH (e.g., whether on-demand SIB1 is transmitted, or whether the CORESET for SIB1 is present when the CORESET for SIB0 is different from the CORESET for SIB1).
   For yet another further instance, there can be a field (e.g., a bitmap) in the PBCH payload indicating whether to monitor the SIB0-PDCCH and/or the SIB1-PDCCH (e.g., each bit indicating a corresponding SIB).
   For yet another further instance, this can be applicable at least for SIB0/SIB1 transmission pattern 1.
For yet another sub-instance, the UE monitors SIB0-PDCCH when the on-demand SIB1 is not transmitted, and monitors SIB1-PDCCH when the on-demand SIB1 is transmitted.
   For one further instance, there can be a field (e.g., one-bit indication or indication by k_SSB value) in the PBCH payload indicating whether to monitor the SIB0-PDCCH or the SIB1-PDCCH (e.g., whether on-demand SIB1 is transmitted, or whether the CORESET for SIB1 is present when the CORESET for SIB0 is different from the CORESET for SIB1).
   For another further instance, there can be a field (e.g., a bitmap) in the PBCH payload indicating whether to monitor the SIB0-PDCCH and/or the SIB1-PDCCH (e.g., each bit indicating a corresponding SIB).
   For yet another further instance, this can be applicable at least for SIB0/SIB1 transmission pattern 2.

For one example, SIB0 can be carried by a physical downlink shared channel (PDSCH), wherein the PDSCH is scheduled by a physical downlink control channel (PDCCH). The PDCCH and PDSCH for SIB0 can be denoted as SIB0-PDCCH and SIB0-PDSCH, respectively.

For one instance, SIB0-PDCCH can be same as SIB1-PDCCH, e.g., a single DCI format carrying the information (e.g., scheduling information) for the SIB0-PDSCH and/or the information (e.g., scheduling information) for the SIB1-PDSCH.
For one sub-instance, the configurations for CORESET and/or search space set for monitoring SIB0-PDCCH/SIB1-PDCCH can be included in the payload of PBCH (e.g., MIB).
For another sub-instance, the DCI format in the SIB0-PDCCH/SIB1-PDCCH can carry the information related to the SIB0-PDSCH by default, and also include the information related to the SIB1-PDSCH when the on-demand SIB1 is transmitted.
   For one further instance, there can be a field (e.g., one-bit indication) in the DCI format indicating whether the DCI format includes the information related to the SIB1-PDSCH (e.g., whether on-demand SIB1 is transmitted).
   For another further instance, there can be a field (e.g., one-bit indication or indication by k_SSB value) in the PBCH payload indicating whether the DCI format includes the information related to the SIB1-PDSCH (e.g., whether on-demand SIB1 is transmitted).
   For yet another further instance, this can be applicable at least for SIB0/SIB1 transmission pattern 1.
For yet another sub-instance, the DCI format in the SIB0-PDCCH/SIB1-PDCCH can carry the information related to the SIB0-PDSCH when the on-demand SIB1 is not transmitted, and include the information related to the SIB1-PDSCH when the on-demand SIB1 is transmitted.
   For one further instance, there can be a field (e.g., one-bit indication) in the DCI format indicating whether the DCI format includes the information related to the SIB0-PDSCH or the information related to the SIB1-PDSCH (e.g., whether on-demand SIB1 is transmitted).
   For another further instance, there can be a field (e.g., one-bit indication or indication by k_SSB value) in the PBCH payload indicating whether the DCI format includes the information related to the SIB0-PDSCH or the information related to the SIB1-PDSCH (e.g., whether on-demand SIB1 is transmitted).
   For yet another further instance, this can be applicable at least for SIB0/SIB1 transmission pattern 2.

For another instance, SIB0-PDCCH can be different from SIB1-PDCCH.
For one sub-instance, the configurations for CORESET for SIB0-PDCCH/SIB1-PDCCH can be the same, and included in the payload of PBCH (e.g., MIB).
For another sub-instance, the configurations for CORESET for the SIB0-PDCCH and the configurations for CORESET for the SIB1-PDCCH can be the different.
   For one further instance, the configurations for CORESET for the SIB0-PDCCH can be included in the payload of PBCH (e.g., MIB), and the configurations for CORESET for the SIB1-PDCCH can be included in the SIB0.
   For another further instance, the configurations for CORESET for the SIB0-PDCCH can be included in the payload of PBCH (e.g., MIB), and the configurations for CORESET for the SIB1-PDCCH can be determined based on the configurations for CORESET for the SIB0-PDCCH, such as the same number of OFDM symbols and FDMed with CORESET for the SIB0-PDCCH, or the same number of RBs and TDMed with CORESET for the SIB0-PDCCH.
   For one further instance, the configurations for CORESET for the SIB0-PDCCH can be included in the payload of PBCH (e.g., MIB), and the configurations for CORESET for the SIB1-PDCCH can be also included in the payload of PBCH (e.g., MIB), such as two different fields, or at least one field for common configurations for the two CORESETs and another at least one field for unique configurations for each CORESET respectively, or one field for configurations for one of the CORESETs and another at least one field for indicating difference (e.g., time and/or frequency domain offset) from the configurations for one of the CORESETs to determine the configurations for the other of the CORESETs.
   For one further instance, the configurations for CORESET for the SIB0-PDCCH can be determined (e.g., time and/or frequency domain can be determined based on the associated SSB), and/or the configurations for CORESET for the SIB1-PDCCH can be included in the payload of PBCH (e.g., MIB).
   For one further instance, the configurations for CORESET for the SIB0-PDCCH can be determined (e.g., time and/or frequency domain can be determined based on the associated SSB), and/or the configurations for CORESET for the SIB1-PDCCH can be included in the SIB0.
For another sub-instance, the configurations for the search space set for monitoring SIB0-PDCCH/SIB1-PDCCH can be the same, and included in the payload of PBCH (e.g., MIB).
For yet another sub-instance, the configurations for search space set for monitoring the SIB0-PDCCH and the configurations for search space set for monitoring the SIB1-PDCCH can be the different.
   For one further instance, the configurations for search space set for monitoring the SIB0-PDCCH can be included in the payload of PBCH (e.g., MIB), and the configurations for search space set for monitoring the SIB1-PDCCH can be included in the SIB0.
   For another further instance, the configurations for search space set for monitoring the SIB0-PDCCH can be included in the payload of PBCH (e.g., MIB), and the configurations for search space set for monitoring the SIB1-PDCCH can be determined based on the configurations for search space set for monitoring the SIB0-PDCCH, such as with a pre-defined or configured time domain offset.
   For one further instance, the configurations for search space set for monitoring the SIB0-PDCCH can be included in the payload of PBCH (e.g., MIB), and the configurations for search space set for monitoring the SIB1-PDCCH can be also included in the payload of PBCH (e.g., MIB), such as two different fields, or at least one field for common configurations for the two search space sets and another at least one field for unique configurations for each search space set respectively, or one field for configurations for one of the search space sets and another at least one field for indicating difference (e.g., time and/or frequency domain offset) from the configurations for one of the search space sets to determine the configurations for the other of the search space sets.
   For one further instance, the configurations for the search space set for monitoring the SIB0-PDCCH can be determined (e.g., time and/or frequency domain can be determined based on the associated SSB), and/or the configurations for the search space set for monitoring the SIB1-PDCCH can be included in the payload of PBCH (e.g., MIB).
   For one further instance, the configurations for the search space set for monitoring the SIB0-PDCCH can be determined (e.g., time and/or frequency domain can be determined based on the associated SSB), and/or the configurations for the search space set for monitoring the SIB1-PDCCH can be included in the SIB0.
For yet another sub-instance, a first DCI format in the SIB0-PDCCH can carry the information related to the SIB1-PDSCH, and a second DCI format in the SIB1-PDCCH can carry the information related to the SIB1-PDSCH.
For yet another sub-instance, the UE monitors SIB0-PDCCH, and also monitors SIB1-PDCCH when the on-demand SIB1 is transmitted.
   For one further instance, there can be a field (e.g., one-bit indication) in the first DCI format indicating whether to monitor the SIB1-PDCCH (e.g., whether on-demand SIB1 is transmitted, or whether the CORESET for SIB1 is present when the CORESET for SIB0 is different from the CORESET for SIB1).
   For another further instance, there can be a field (e.g., one-bit indication or indication by k_SSB value) in the PBCH payload indicating whether to monitor the SIB1-PDCCH (e.g., whether on-demand SIB1 is transmitted, or whether the CORESET for SIB1 is present when the CORESET for SIB0 is different from the CORESET for SIB1).
   For yet another further instance, there can be a field (e.g., a bitmap) in the PBCH payload indicating whether to monitor the SIB0-PDCCH and/or the SIB1-PDCCH (e.g., each bit indicating a corresponding SIB).
   For yet another further instance, this can be applicable at least for SIB0/SIB1 transmission pattern 1.
For yet another sub-instance, the UE monitors SIB0-PDCCH when the on-demand SIB1 is not transmitted, and monitors SIB1-PDCCH when the on-demand SIB1 is transmitted.
   For one further instance, there can be a field (e.g., one-bit indication or indication by k_SSB value) in the PBCH payload indicating whether to monitor the SIB0-PDCCH or the SIB1-PDCCH (e.g., whether on-demand SIB1 is transmitted, or whether the CORESET for SIB1 is present when the CORESET for SIB0 is different from the CORESET for SIB1).
   For another further instance, there can be a field (e.g., a bitmap) in the PBCH payload indicating whether to monitor the SIB0-PDCCH and/or the SIB1-PDCCH (e.g., each bit indicating a corresponding SIB).
   For yet another further instance, this can be applicable at least for SIB0/SIB1 transmission pattern 2.

For yet another instance, SIB0-PDSCH can be according to at least one of the following sub-instances (including combination of sub-instances).
For one sub-instance, the SIB0-PDSCH locates within the same slot as SIB0-PDCCH, e.g., the slot offset between SIB0-PDCCH and the SIB0-PDSCH is 0.
For another sub-instance, the time domain and/or frequency domain resources for the SIB0-PDSCH are located in the same slot and same carrier bandwidth as the SSB associated with the SIB0-PDSCH.
For yet another sub-instance, the OFDM symbols for SIB0-PDSCH are same as or a subset of the OFDM symbols for the SSB associated with the SIB0-PDSCH.
For yet another sub-instance, the RBs for SIB0-PDSCH are not overlapping with the SSB associated with the SIB0-PDSCH.
For yet another sub-instance, the time domain and/or frequency domain resources for the SIB0-PDSCH can be fixed or pre-determined (e.g., based on the CORESET configuration and/or resources for the SSB associated with the SIB0-PDSCH).
   For one instance, the OFDM symbols for SIB0-PDSCH are same as the OFDM symbols for the SSB associated with the SIB0-PDSCH.
   For another instance, the RBs for SIB0-PDSCH can equal to the remaining RBs of the RBs that the SSB occupies from the RBs of the CORESET.
For yet another sub-instance, the time domain and/or frequency domain resources for the SIB0-PDSCH can be a subset of the time domain and/or frequency domain resources for the SIB1-PDSCH.
   For one instance, the configurations (e.g., from a table) for the time domain resources for the SIB0-PDSCH can be a subset of the configurations for the time domain resources for the SIB1-PDSCH.
   For another instance, when indicating the time domain and/or frequency domain resources for the SIB0-PDSCH (e.g., by SIB0-PDCCH), the indication can be indicating a subset of or an offset from the time domain and/or frequency domain resources for the SIB1-PDSCH.
   For yet another instance, when indicating the time domain and/or frequency domain resources for the SIB1-PDSCH (e.g., by SIB1-PDCCH), the indication can be indicating an offset from the time domain and/or frequency domain resources for the SIB0-PDSCH.

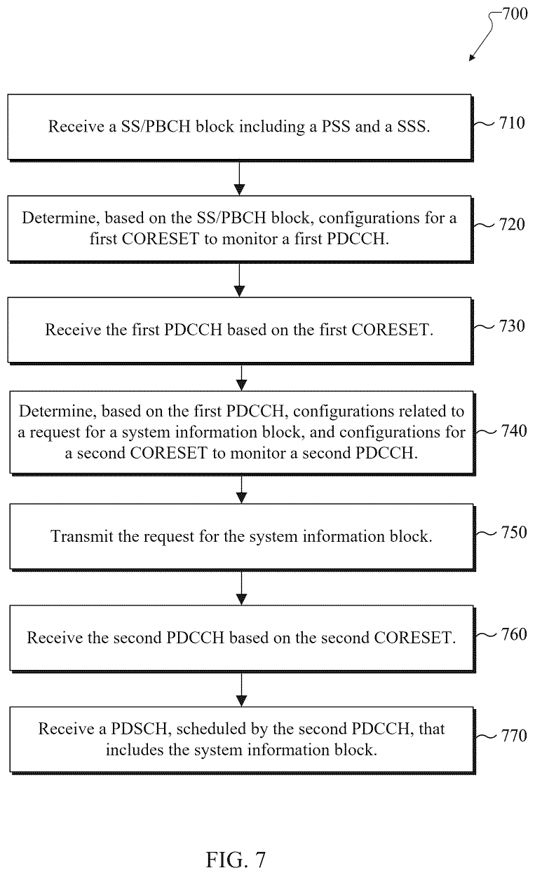

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method 700 begins with the UE receiving a SS/PBCH block including a PSS and a SSS (710). The UE then determines, based on the SS/PBCH block, configurations for a first CORESET to monitor a first PDCCH (720). In various embodiments, the first CORESET is FDMed with the SS/PBCH block. In various embodiments, the configurations for the first CORESET are included in a MIB of the SS/PBCH block. In various embodiments, a first starting symbol for a search space set to monitor the first PDCCH is aligned with a second starting symbol of the SS/PBCH block.

The UE then receives the first PDCCH based on the first CORESET (730). The UE then determines, based on the first PDCCH, configurations related to a request for a system information block, and configurations for a second CORESET to monitor a second PDCCH (740). In various embodiments, the UE determines, based on the first PDCCH, configurations for a downlink indication including a confirmation on the request for the system information block and receive the downlink indication. In various embodiments, the configurations related to the request for the system information block and the configurations for the second CORESET are included in a DCI format carried by the first PDCCH. In various embodiments, a first DM-RS associated with the first PDCCH is QCLed with the SS/PBCH block and a second DM-RS associated with the second PDCCH is QCLed with the SS/PBCH block.

The ULE then transmits the request for the system information block (750). The UE then receives the second PDCCH based on the second CORESET (760). The UE then receives a PDSCH, scheduled by the second PDCCH, that includes the system information block (770).

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) in a wireless communication system, the BS comprising:
a processor configured to:
determine configurations for a first control resource set (CORESET) to monitor a first physical downlink control channel (PDCCH);
determine configurations related to a request for a system information block; and
determine configurations for a second CORESET to monitor a second PDCCH; and
a transceiver operably coupled to the processor, the transceiver configured to:
transmit a synchronization signals and physical broadcast channel (SS/PBCH) block including a primary synchronization signal (PSS) and a secondary synchronization signal (SSS), wherein the SS/PBCH block includes the configurations for the first CORESET;
transmit the first PDCCH based on the first CORESET, wherein the first PDCCH includes (i) the configurations related to the request for the system information block and (ii) the configurations for the second CORESET;
receive the request for the system information block;
transmit the second PDCCH based on the second CORESET; and
transmit a physical downlink shared channel (PDSCH) scheduled by the second PDCCH, wherein the PDSCH includes the system information block.

2. The BS of claim 1, wherein the first CORESET is frequency division multiplexed (FDMed) with the SS/PBCH block.

3. The BS of claim 1, wherein the configurations for the first CORESET are included in a master information block (MIB) of the SS/PBCH block.

4. The BS of claim 1, wherein a first starting symbol for a search space set to monitor the first PDCCH is aligned with a second starting symbol of the SS/PBCH block.

5. The BS of claim 1, wherein:
the processor is further configured to determine, based on the first PDCCH, configurations for a downlink indication including a confirmation on the request for the system information block; and
the transceiver is further configured to transmit the downlink indication.

6. The BS of claim 1, wherein the configurations related to the request for the system information block and the configurations for the second CORESET are included in a downlink control information (DCI) format carried by the first PDCCH.

7. The BS of claim 1, wherein:
a first de-modulation reference signal (DM-RS) associated with the first PDCCH is quasi-co-located (QCLed) with the SS/PBCH block; and
a second DM-RS associated with the second PDCCH is QCLed with the SS/PBCH block.

8. A user equipment (UE) in a wireless communication system, the UE comprising:
a transceiver configured to receive a synchronization signals and physical broadcast channel (SS/PBCH) block including a primary synchronization signal (PSS) and a secondary synchronization signal (SSS); and
a processor operably coupled to the transceiver, the processor configured to determine, based on the SS/PBCH block, configurations for a first control resource set (CORESET) to monitor a first physical downlink control channel (PDCCH);
wherein the transceiver is further configured to receive the first PDCCH based on the first CORESET,
wherein the processor is further configured to determine, based on the first PDCCH, (i) configurations related to a request for a system information block and (ii) configurations for a second CORESET to monitor a second PDCCH, and
wherein the transceiver is further configured to:
transmit the request for the system information block;
receive the second PDCCH based on the second CORESET; and
receive a physical downlink shared channel (PDSCH) scheduled by the second PDCCH, wherein the PDSCH includes the system information block.

9. The UE of claim 8, wherein the first CORESET is frequency division multiplexed (FDMed) with the SS/PBCH block.

10. The UE of claim 8, wherein the configurations for the first CORESET are included in a master information block (MIB) of the SS/PBCH block.

11. The UE of claim 8, wherein a first starting symbol for a search space set to monitor the first PDCCH is aligned with a second starting symbol of the SS/PBCH block.

12. The UE of claim 8, wherein:
the processor is further configured to determine, based on the first PDCCH, configurations for a downlink indication including a confirmation on the request for the system information block; and
the transceiver is further configured to receive the downlink indication.

13. The UE of claim 8, wherein the configurations related to the request for the system information block and the configurations for the second CORESET are included in a downlink control information (DCI) format carried by the first PDCCH.

14. The UE of claim 8, wherein:
a first de-modulation reference signal (DM-RS) associated with the first PDCCH is quasi-co-located (QCLed) with the SS/PBCH block; and
a second DM-RS associated with the second PDCCH is QCLed with the SS/PBCH block.

15. A method of a user equipment (UE) in a wireless communication system, the method comprising:
receiving a synchronization signals and physical broadcast channel (SS/PBCH) block including a primary synchronization signal (PSS) and a secondary synchronization signal (SSS);
determining, based on the SS/PBCH block, configurations for a first control resource set (CORESET) to monitor a first physical downlink control channel (PDCCH);
receiving the first PDCCH based on the first CORESET;
determining, based on the first PDCCH, (i) configurations related to a request for a system information block, and (ii) configurations for a second CORESET to monitor a second PDCCH;
transmitting the request for the system information block;
receiving the second PDCCH based on the second CORESET; and
receiving a physical downlink shared channel (PDSCH) scheduled by the second PDCCH, wherein the PDSCH includes the system information block.

16. The method of claim 15, wherein the first CORESET is frequency division multiplexed (FDMed) with the SS/PBCH block.

17. The method of claim 15, wherein:
the configurations for the first CORESET are included in a master information block (MIB) of the SS/PBCH block; and
a first starting symbol for a search space set to monitor the first PDCCH is aligned with a second starting symbol of the SS/PBCH block.

18. The method of claim 15, further comprising:
determining, based on the first PDCCH, configurations for a downlink indication including a confirmation on the request for the system information block; and
receiving the downlink indication.

19. The method of claim 15, wherein the configurations related to the request for the system information block and the configurations for the second CORESET are included in a downlink control information (DCI) format carried by the first PDCCH.

20. The method of claim 15, wherein:
a first de-modulation reference signal (DM-RS) associated with the first PDCCH is quasi-co-located (QCLed) with the SS/PBCH block; and
a second DM-RS associated with the second PDCCH is QCLed with the SS/PBCH block.
